(19) United States
(12) Patent Application Publication
(10) Pub. No.: US 2012/0053818 A1
(43) Pub. Date: Mar. 1, 2012

(54) Ignition device for a combustion engine

(76) Inventors: Martin SACKMANN, Benningen (DE); Bernd LAST, Reutlingen (DE); Karsten VOLLAND, Ludwigsburg (DE)

(21) Appl. No.: 13/216,536

(22) Filed: Aug. 24, 2011

(30) Foreign Application Priority Data
Aug. 26, 2010 (DE) 10 2010 035 422.8

(51) Int. Cl. F02B 1/02; F02D 28/00; F23Q 3/00; F23Q 7/22; F23Q 13/00

(52) U.S. Cl. 701/102; 123/143 R; 123/145 A; 123/169 R; 123/169 E

(57) ABSTRACT

The invention describes an ignition device for a combustion engine with one or several combustion chambers, to each of which an ignition device is associated and exhibits a sensor which reacts to a measurand, which is influenced by a combustion cycle taking place in the respective combustion chamber. According to the invention it is provided that the sensor is an acceleration sensor.

The invention concerns an ignition device for a combustion engine with one or several combustion chambers, to each of which an ignition device is associated that comprises a sensor, which reacts to a measurand, which is influenced by a combustion cycle taking place in the respective combustion chamber. Such an ignition device is described in the article by Hans Houben et al. with the title “Pressure sensor glow plug (PSG) for diesel engines”, Journal MTZ11/2004. This publication describes a glow plug for diesel engine, in which a pressure sensor is integrated, which enables to measure the pressure in a combustion chamber, into which the glow plug protrudes. The pressure prevailing in the combustion chamber is transmitted from the heating rod of the glow plug to a stainless steel membrane arranged in the housing of the glow plug, to which micromechanical, monocrystalline silicon resistive wire strains are bonded which form a Wheatstone bridge. The heating rod of the glow plug is mounted elastically mobile in the glow plug housing for that purpose. The Wheatstone bridge is connected to an engine control device. The engine control device can regulate the combustion cycle depending on the magnitude and the variation in time of the pressure in the combustion chamber. However, this advantage is the fruit of an expensive construction of the glow plug with its mobile heating rod.

### SUMMARY OF THE INVENTION

An object of the present invention is to provide for a solution enabling to determine with less effort a measurand value that is suitable for controlling the combustion process.

This object is met by an ignition device having the features specified in claim 1 and by a combustion engine fitted with such an ignition device. Advantageous further embodiments of the invention are described in the sub-claims.

According to the invention, the sensor, which reacts to a measurand, which is influenced by a combustion process taking place in the respective combustion chamber, is an acceleration sensor and this sensor is provided for every combustion chamber of the combustion engine in the ignition device which is associated to the respective combustion chamber of the combustion engine.

It has surprisingly appeared that a measurand can be acquired with acceleration sensors, which is characteristic of the progression of the combustion process in each individual combustion chamber of a combustion engine and can therefore be used individually for regulating the combustion cycle in the various combustion chambers, when it is the ignition device associated with the respective combustion chamber, which includes the acceleration sensor.

The invention has significant advantages:
Otherwise than in the case of a pressure measuring glow plug, no mobile component, which records the combustion pressure and transmits it to a sensor, is required when using an acceleration sensor in the ignition device.
An acceleration sensor can be incorporated in a glow plug, without requiring to install the heating rod of the glow plug in a mobile fashion as is the case with a pressure measuring glow plug.
The means needed to integrate an acceleration sensor into a glow plug are substantially smaller than the means needed to integrate a pressure sensor into a glow plug.
The invention lends it for use not only for diesel engines, but also for Otto engines and for petrol engines.
A acceleration sensor can also be incorporated into a spark plug or into the housing of an ignition coil or be installed on the housing of an ignition coil. It can further be incorporated into an ignition device, through which a corona discharge is generated between an electrode protruding into the combustion chamber and a wall delineating the combustion chamber, through which a fuel-air-mixture can be ignited. Ignition devices with which a corona discharge is generated are disclosed in documents WO2004/063560 A1 and WO 2010/011838 A1.
The combustion pressure cannot be measured directly with an acceleration sensor arranged according to the invention in an ignition device. Since the combustion pressure is not a static value, but a dynamic, constantly changing measurand, the temporal modifications of the combustion pressure influence in a characteristic fashion the variation in time of the acceleration signal delivered by the acceleration sensor so that the acceleration signal nevertheless gives an information about the variation in time of the combustion pressure in the combustion chamber. This makes the use of an acceleration sensor according to the invention particularly suitable for regulating, by means of the acceleration signal delivered by the acceleration sensor, the combustion process in the respective combustion chamber using an engine control device.
Using the signals acquired by the acceleration sensors, an engine control device can control the combustion processes taking place in the engine in such a way that preset targets such as for instance reduced emission, reduced fuel consumption and/or reduced noise are achieved.

There is still a whole range of additional advantageous applications for the acceleration sensor according to the invention deployed in an ignition device:
It can be used for establishing combustion parameters, such as for instance AQ10 and AQ50. That is the angular position of the crankshaft, at which 10% (AQ10) respectively 50% (AQ50) of the fuel is transformed.
It can be used for determining the noise level and signalling unusual alterations of the noise level, so that they can be displayed to the driver or stored in the on-board computer for diagnostic purposes.
It can acquire knocking sounds. In contrast to a knock sensor usually mounted on the engine block it can acquire knocking sounds not only for the combustion engine as a whole, but rather separately for every combustion chamber.
It can recognise vibrations which are generated by other components such as for instance by compensation shafts or turbo chargers. For this, the signals of the acceleration sensor can be submitted to a frequency analysis for instance and be monitored for the occurrence of characteristic and/or unusual frequencies and amplitudes as well as for resonances, which may cause damages or indicate damages.
It can be used, during the development phase of the engine and its ignition devices, for carrying out highly accelerated life cycle testing, known to the skilled person as HALT (Highly Accelerated Life Test), and/or for determining parameters for an operating strength analysis of the ignition devices.

Such an element is more appropriately used as an acceleration sensor which delivers an electrical output signal. The electrical output signal can be conveyed to a control apparatus or regulation apparatus, in which it can be processed, interpreted and resorted to for the purposes of a control unit or regulation of the combustion cycles in the engine. But the electrical output signal can also be processed and interpreted in the ignition device already, if this device comprises to that end a corresponding electrical respectively electronic circuit. Such a circuit can be provided in the rear, cooler section of a glow plug, of a spark plug, in a high-frequency ignition device for generating a corona discharge and also in the or on the housing of an ignition coil. Such a circuit for processing and interpreting the signals of an acceleration sensor can for its own part be connected with an input of an open or closed loop control apparatus, in particular with an engine control device provided nonetheless with advanced engines.

For the purposes of the invention, acceleration sensors for instance are suitable, which have a seismic mass which is pressed by a spring against a piezoelectric body generating electrical signals by using the piezoelectric effect. Such acceleration sensors are known to those skilled in the art.

Alternately, MEMS Sensors can also be used as acceleration sensors for the purposes of the invention. MEMS designates an acceleration sensor on the basis of a micro-electro-mechanical system. These are miniaturised acceleration sensors. They comprise for instance miniaturised spring-mass systems, in which the springs are only few micron wide silicon webs, on which a mass body also consisting of silicon is suspended elastically. When acceleration occurs, the mass body suspended elastically is deflected and changes its distance from a fixed reference electrode. The electrical capacity between the mass body and the reference electrode is thereby changed and this change in capacity is measured as standard for the acceleration. MEMS Sensors are also known to those skilled in the art.

If the ignition device has a component with a longitudinal axis, the acceleration sensor is then arranged preferably coaxially to the longitudinal axis of this component in the ignition device, preferably in such a way that the acceleration sensor or a unit including the acceleration sensor encloses coaxially the corresponding component. A unit including the acceleration sensor can advantageously contain an electrical circuit, in particular with a microprocessor or similar micro-electronic constitutive element, in which the signals delivered by the acceleration sensor can be processed. For a diesel engine, the acceleration sensor is preferably arranged in the glow plugs. Glow plugs have a heating rod whose tip reaches into the combustion chamber. The acceleration sensor or a unit including it can be annular and could be arranged in such a way that it encloses the heating rod on its end remote from the combustion chamber. The temperatures occurring at this end are low enough for the acceleration sensors of the art described previously to be able to withstand them.

Glow plugs usually have a metal housing which is also designated as a glow plug body in which the heating rod is held which protrudes into the combustion chamber with its glow tip. An electrical connection device is provided on the rear end of the housing of the glow plug. An electrical supply line leads from the connection device to the heating rod. This supply line is also called the internal pole of the glow plug. The acceleration sensor can be arranged in the housing of the glow plug in such a way that it encloses this electrical supply line, the internal pole. Preferably it is held in a recess of the housing of the glow plug. The temperatures occurring in this area of the glow plug are even lower than at the rear end of the heating rod. The signals of the acceleration sensor respectively the output signals of a circuit, which has processed the signals of the acceleration sensor, can be transmitted from the glow plug via the electrical connection device on the rear end of the housing of the glow plug.

In an Otto engine, the acceleration sensor can be arranged in the spark plugs. The spark plugs usually have a metal housing, an electrode passing centrally through the housing—the middle electrode—and an insulating body holding the middle electrode and electrically insulating said electrode from the housing. Preferably, the acceleration sensor respectively a unit including the acceleration sensor encloses the insulating body and is preferably arranged and held in a ring-shaped recess formed between the inside of the housing and the outside of the insulating body. The recess can be arranged in the insulating body or in the inside of the housing or partially in the insulating body and partially in the inside of the housing. Providing that the recess is formed in the insulating body, said recess can be obtained by powder metallurgy by means of corresponding shaping of the die without additional means implemented.

Glow plugs and spark plugs are usually screwed in a threaded bore and should hermetically close the respective combustion chamber, for which purpose a sealing seat is provided in the wall of the combustion chamber, which co-operates with a complementary sealing surface of the glow plug respectively of the spark plug. The acceleration sensor is preferably arranged in the case of glow plugs as well as in the case of spark plugs in the height of the sealing seat. Such an arrangement is particularly suitable since it guarantees that accelerations occurring on the combustion chamber and in particular those occurring on the roof of the combustion chamber are transmitted to the acceleration sensor with minimal damping and in a high bandwidth. Moreover, such an arrangement provides a good thermal connection of the acceleration sensor to the cooled cylinder block respectively cylinder head of the engine, which causes the temperature of the sensor to reliably remain below the temperature of 150° C. which is critical for electrical components. By roof of the combustion chamber is meant the wall of the combustion chamber through which the alternation of load (supply of air and fuel, emission of the exhaust gas) takes place and through which the glow plug respectively spark plug protrudes into the combustion space. In the case of an engine with reciprocating pistons, a removable cylinder head usually forms the combustion chamber roof.

It has appeared that even when the acceleration sensor is fastened in or on a housing of an ignition coil, the coupling of the acceleration sensor to the respective combustion chamber is still sufficient to transmit the accelerations occurring at or on the combustion chamber and in particular those occurring on the combustion chamber roof to the acceleration sensor with sufficiently low damping and in a sufficiently high bandwidth, so that the acceleration sensor can detect even in such an arrangement accelerations caused by processes in the respective combustion chamber. The ignition coil respectively the housing with the ignition coil is preferably fastened to the combustion chamber roof directly. The housing of the ignition coil preferably has a fixing eye with which the housing can be fastened to a stud, which is formed on the combustion chamber roof of the engine. In such a case, the acceleration sensor is preferably arranged on the fixing eye of the housing of the ignition coil because the mechanical coupling to the combustion chamber roof is particularly good there. In particular the acceleration sensor or a unit including the acceleration sensor is preferably annular so that it encloses the journal to which the fixing eye is fastened.

If the engine has an HF ignition device, by means of which a corona discharge is generated in the combustion chambers, then the acceleration sensor is provided preferably in the housing of this ignition device. Such an ignition device can comprise an HF spark plug, which may have a slim, predominantly cylindrical housing similar to the housing of a glow plug. An electrode is preferably run coaxially through this housing, which electrode is electrically insulated with respect to the housing. A coil and/or a capacitor of a high-frequency resonant circuit can be arranged in the rear region of the housing. Also in such a case of a HF spark plug it is recommended as with a glow plug and as with a conventional spark plug to use coaxial arrangement of the acceleration sensor or of a unit including the acceleration sensor in the housing of the high-frequency spark plug. The criteria according to which an acceleration sensor is arranged in the spark plug and in a glow plug and according to which a certain type of acceleration sensors is selected are also valid correspondingly for the integration of an acceleration sensor in an HF spark plug. The advantages, which according to the invention have spark plugs and glow plugs equipped with an acceleration sensor, are valid correspondingly for HF spark plugs, which according to the invention are equipped with an acceleration sensor.

### BRIEF DESCRIPTION OF THE DRAWINGS

The accompanying schematic drawings provide better explanation of the invention. The drawings include the following figures:

FIG. 1 is a schematic diagram of a combustion chamber of an combustion engine with a glow plug and a control apparatus,

FIG. 2 shows a cut-out of a cylinder head,

FIG. 3 shows a first glow plug with integrated annular acceleration sensor in longitudinal section,

FIG. 4 shows a second glow plug with integrated annular acceleration sensor in a longitudinal section,

FIG. 5 shows a third glow plug with integrated annular acceleration sensor in a longitudinal section,

FIG. 6 shows an enlarged detailed section of FIG. 3,

FIG. 7 shows a fourth glow plug with an MEMS acceleration sensor in a longitudinal section,

FIG. 8 shows a detailed section of FIG. 7,

FIG. 9 is a schematic diagram of a combustion chamber of a glow plug according to the invention and a control apparatus,

FIG. 10 shows a first spark plug with integrated acceleration sensor in a longitudinal section,

FIG. 11 shows a second spark plug with integrated acceleration sensor in a longitudinal section

FIG. 12 shows a schematic diagram of a combustion chamber with spark plug and ignition coil and with an integrated acceleration sensor,

FIG. 13 shows a housing with built-in ignition coil and with integrated acceleration sensor in an oblique view,

FIG. 14 shows the housing of FIG. 13 in a side view with a fixing eye in a longitudinal section,

FIG. 15 shows a detail of the fixing eye of FIG. 14 in longitudinal section with integrated acceleration sensor, and

FIG. 16 shows a variation of the arrangement illustrated in FIG. 15.

### DETAILED DESCRIPTION

Identical and correlating parts are designated with matching reference numbers in the different drawings.

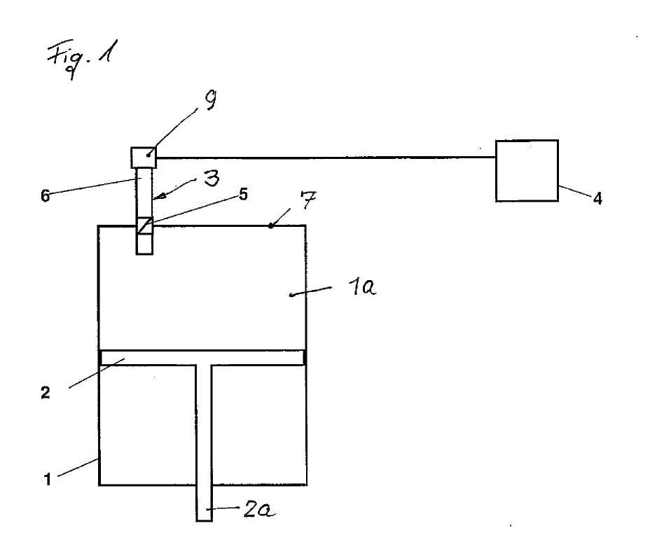

FIG. 1 shows diagrammatically a combustion chamber 1 in the form of a cylinder fitted with a piston 2 and a connecting rod 2a mounted thereon. The combustion chamber 1 is closed upwards by means of a combustion chamber roof 7. The combustion takes place in the space 1a between the piston 2 and the combustion chamber roof 7. For this reason, the space 1a is here called combustion space. A glow plug 3 is inserted into the combustion chamber roof 7. This glow plug is connected to a control apparatus 4. The control apparatus 4 can be an engine control device controlling the engine functions, it can also be a separate control device for the glow plug of the combustion engine, which is also called glow control apparatus. An acceleration sensor 5 is provided in the housing 6 of the glow plug 3, in addition to the components which usually form a glow plug. The sensor can be combined with an analysing circuit or parts of an analysing circuit to constitute a unit for processing the measuring signals delivered by the acceleration sensor 5. If the interpreting circuit is not provided in the housing 6 of the glow plug 3 it can be situated in the control apparatus 4.

The acceleration sensor 5 can be single axis, double axis or triple axis, i.e. it can measure accelerations, which occur in one, in two or in three different space axes. Due to its arrangement in the combustion chamber roof 7 or on the combustion chamber roof 7, the acceleration sensor 5 first and foremost reacts to accelerations which occur on the combustion chamber roof 7 and on the glow plug 3 and is excited first and foremost by the combustion process in the corresponding combustion space 1a and/or possibly by moving components associated with the combustion chamber 1, in particular by the piston 2, by valves belonging to the combustion chamber 1 and the drive elements thereof.

Good mechanical connection of the acceleration sensor 5 to the combustion chamber roof 7 is important, so that the accelerations occurring on the combustion chamber roof 7 are transmitted to the acceleration sensor 5 with smallest possible damping and in a high bandwidth. To that end, an arrangement of the acceleration sensor 5 in the height of the combustion chamber roof 7 and in particular in the combustion chamber roof 7 in the vicinity of its underside is particularly advantageously. Good mechanical connection goes along with good thermal connection of the acceleration sensor 5 to the combustion chamber roof 7. The combustion chamber roof 7, which is generally designed as a removable cylinder head is usually force cooled, i.e. it is streaked with cooling channels 15, through which a cooling fluid of the engine is pumped. The temperature of the acceleration sensor 5 arranged in the height of the combustion chamber roof 7 respectively in the combustion chamber roof 7 will therefore remain below the temperature of 150° C., which is critical for electrical and electronic components.

The dynamic processes, which take place in the combustion chamber 1, are the main cause for the accelerations occurring on the combustion chamber roof 7 and on the glow plug 3. The acceleration signals provided by the acceleration sensor 5, their strength and in particular their variation in time enable to draw conclusions about the combustion process taking place in the combustion chamber 1 and to observe for instance the ignition timing and upon completed ignition the rapidity of the propagation of the flame front. The acceleration sensor 5 integrated into the ignition device can deliver measured values which may be used by an engine control device as input data for controlling the combustion cycle or by a glow control apparatus as input data for controlling the heating process of the glow plug 3.

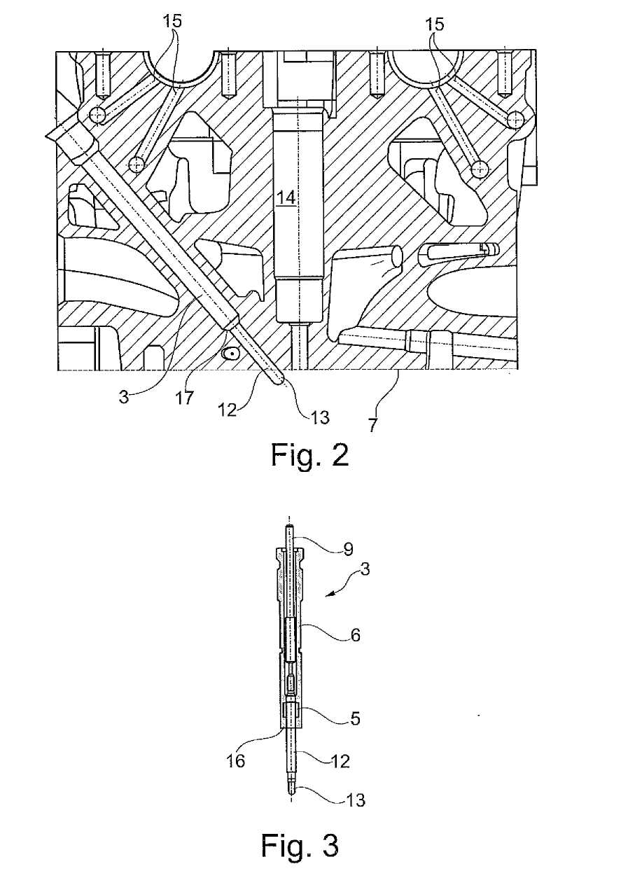

FIG. 2 shows a realistic cut-out of a vertical section through a cylinder head, which closes upwards the combustion chamber 1 of a diesel engine with reciprocating pistons as a combustion chamber roof 7 with its underside. The position of a glow plug 3 is visible, whose predominantly cylindrical housing 6 is inserted in an inclined bore of the cylinder head 7 with good thermal contact. A heating rod 12 reaches into the combustion space 1a with its glow tip 13 from the glow plug housing 6. A channel 14 intended for an injection nozzle emerges into the combustion space 1a close to the glow tip 13. The cylinder head 7 is traversed by a plurality of cooling channels 15.

FIGS. 3 to 5 show three different possibilities of the position at which an acceleration sensor 5 can be arranged in the housing 6 of the glow plug 3.

A conical sealing surface 16 is formed on the front end of the housing 6 of the glow plug 3, which surface co-operates with a reversed conical sealing seat 17, which is provided in the bore of the cylinder head 7 receiving the glow plug 3.

In the embodiment of the glow plug 3 illustrated in FIG. 3, the acceleration sensor 5 is provided in the vicinity of the conical sealing surface 16 of the housing 6 of the glow plug 3 respectively in the vicinity of the sealing seat 17 in the combustion chamber roof 7. This position is ideal for observing the combustion cycles by means of the acceleration sensor 5, since the acceleration sensor 5 rests directly above the combustion space 1a. The cooperation between sealing seat 17 and sealing surface 16 enables to obtain an outstanding mechanical contact with the combustion chamber roof 7. Optimal prerequisites for measuring accelerations are thus provided, accelerations finding their origin in combustion processes which take place in the combustion chamber 1.

The acceleration sensor 5 is annular, rests in a recess 19 of the glow plug housing 6 and preferably encloses coaxially the rear, cool end of the heating rod 12, which, thanks to the good contact over the housing 6 and the sealing seat 17 with the cooled combustion chamber roof 7, remains at a temperature below 150° C.

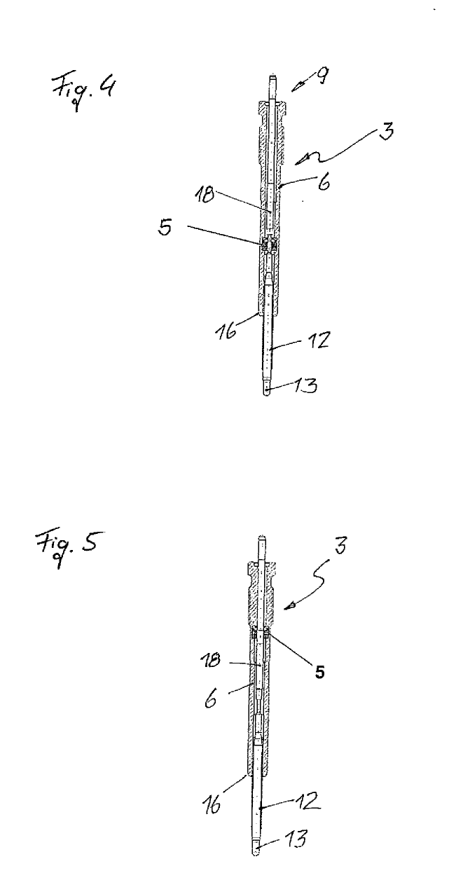

In the exemplary embodiment illustrated in FIG. 4, the acceleration sensor 5 is also annular, however—compared with FIG. 3—shifted further back towards the cold end of the glow plug 3. It is situated approximately medially of the glow plug 3 and preferably encloses coaxially the internal pole 18, through which the heating rod 12 is supplied with current.

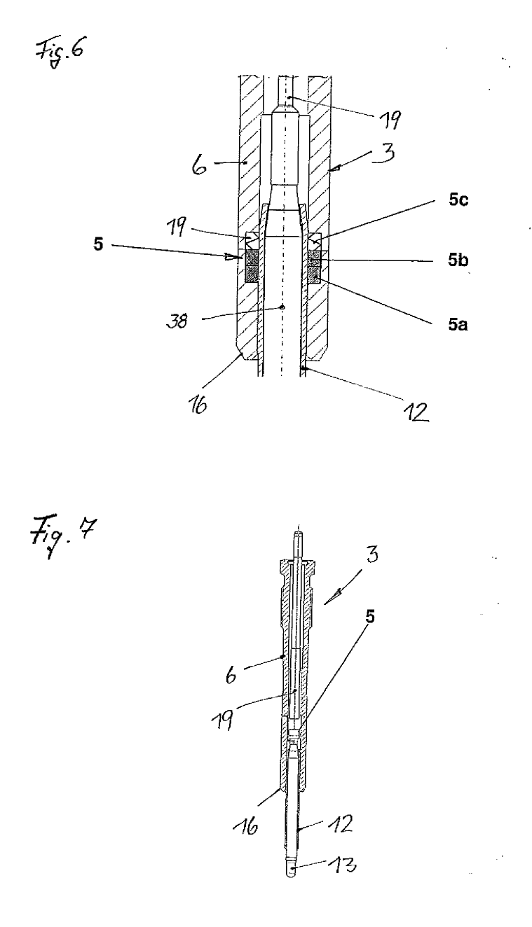

In the exemplary embodiment illustrated in FIG. 5, the acceleration sensor 5 is shifted even further back in the housing 6 of the glow plug 3, it is situated in the vicinity of an electrical glow plug connection 9. Here also, the acceleration sensor 5 is annular, so that the internal pole 18 of the glow plug 3 can be run through it. A screw thread, with which the glow plug 3 is screwed in a bore of the combustion chamber roof 7, is situated directly adjoining the position of the acceleration sensor 5 between the acceleration sensor 5 and the electrical glow plug connection 9. The firm screw connection still enables to transmit ideally the accelerations to be measured as mechanical vibrations to an acceleration sensor 5 arranged in this way. The accelerations are dampened only by the stiffness of the transmitting metal. An arrangement of the acceleration sensor 5 above the thread of the glow plug connection 9 is also possible, but would cause considerable signal loss and is therefore not preferred.

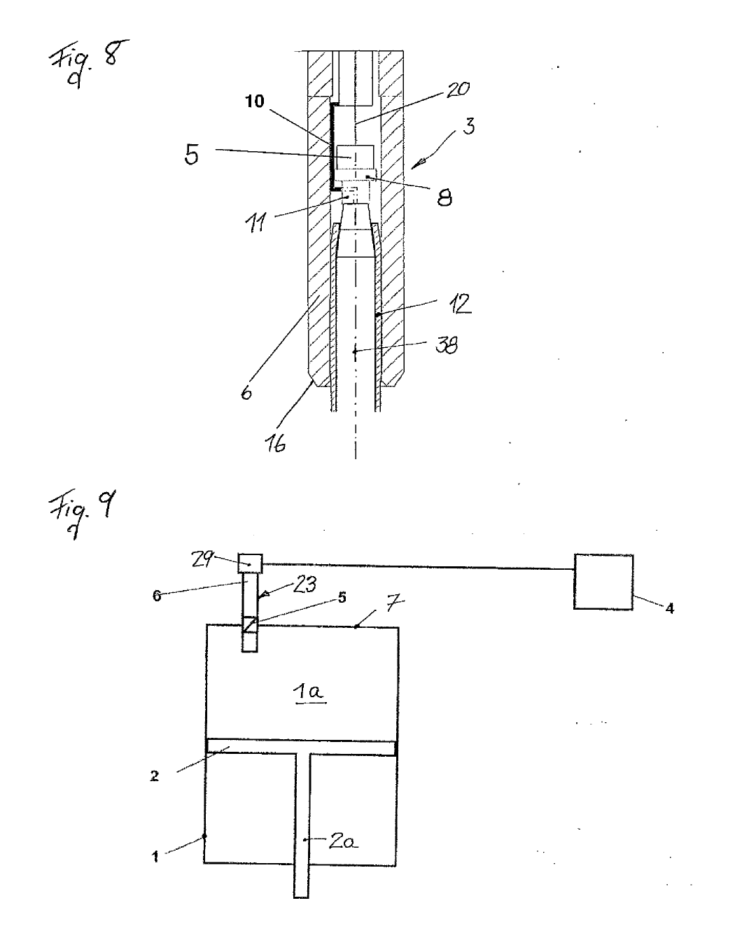

FIG. 6 shows in detail how the acceleration sensor 5 in FIG. 3 can be assembled: It has arranged on top of one another for instance an annular piezoelectric body 5a, an annular seismic mass 5b and an annular spring 5c, which presses the seismic mass 5b against the piezoelectric body 5a. The arrangement of these three elements 5a, 5b and 5c is situated in an annular recess 19 in the housing 6 of the glow plug 3. The recess 19 preferably encloses coaxially the rear end of the heating rod 12 and the longitudinal axis 38 of the glow plug 3 and is open to the heating rod 12.

The piezoelectric body 5a, the seismic mass 5b and the spring 5c could also could be arranged in reverse order in the recess 19, but the acceleration sensor 5 hence formed would be less sensitive than in the arrangement illustrated in FIG. 6, in which the spring 5c is mounted on the side of the seismic mass 5b facing away from the combustion space 1a and the piezoelectric body 5a is mounted on the side of the seismic mass 5b pointing to the combustion space 1a.

Electrical contacts, which abut against the piezoelectric body 5a and there tap the electrical voltage, which is generated by reason of the piezoelectric effect, are not represented in FIG. 6 like the electrical lines, which lead from these contacts to an analyzing circuit arranged outside or inside the housing 6 of the glow plug 3 or partially inside and partially outside the housing 6 of the glow plug 3.

The assembly of the acceleration sensor 5 illustrated in FIG. 6 can be copied correspondingly to the examples of embodiment illustrated in FIGS. 4 and 5.

The electrical lines, leading from the piezoelectric body 5a to an analyzing circuit, can be cables, in particular shielded cables, or shielded or unshielded lines imprinted on a rigid substrate or on a flexible substrate such as for instance a flexfoil. Printed conductor paths can be envisioned first and foremost inside the housing 6 and cables can be envisioned first and foremost outside the housing 6 of the glow plug 3.

When assembling the glow plug 3 illustrated in FIG. 3, it can be proceeded in such a way, that first of all the acceleration sensor 5 is inserted into the recess 19 from the front end of the housing 6 and subsequently the heating rod 12 together with the internal pole 18 is inserted into the housing 6, from the same end, pushing through the acceleration sensor 5, and is fixed in there. To finish, the assembly of the glow plug connection 9 takes place on the rear end of the housing 6.

When assembling the glow plug 3 illustrated in FIG. 4, it can be proceeded in such a way that the acceleration sensor 5, then coming from the glow plug connection 9, is introduced into the recess 19 of the housing 6 of the glow plug 3. The heating rod 12 is then introduced therethrough from the front end of the housing 6 and consequently the internal pole 18 is pushed through the central opening in the acceleration sensor 5 and is fixed in the housing 6 by crimping. To finish, the assembly of the electrical glow plug connection 9 takes place on the rear end of the housing 6.

In the embodiment illustrated in FIG. 5, the glow plug 3 can be assembled in such a way that the heating rod 12 fitted with the internal pole 18 is introduced into the housing 6 from the front end and is fixed therein by crimping. Subsequently, the acceleration sensor 5 is stuck on to the internal pole 18 from the direction of the glow plug connection 9 and introduced into the housing 6. Finally, the electrical glow plug convection 9 is mounted.

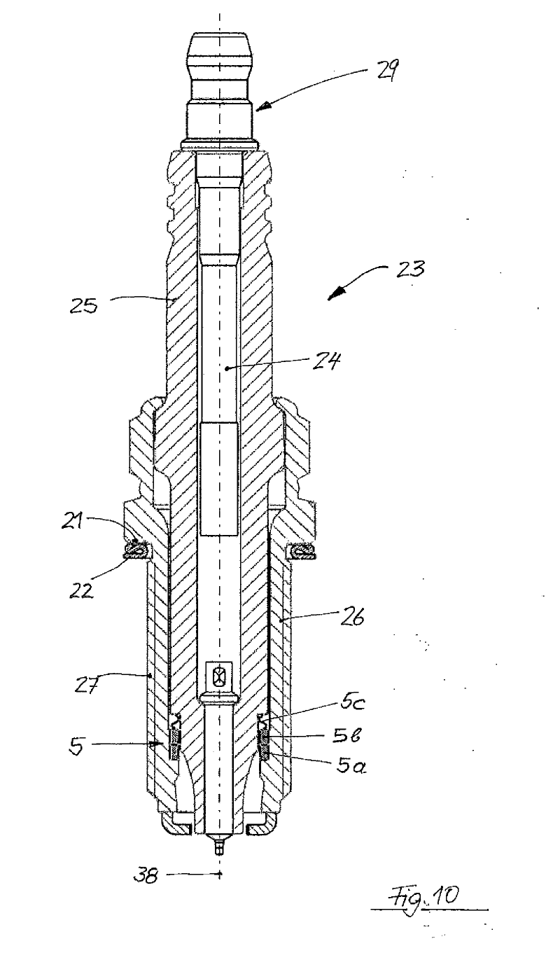

In the embodiment of a glow plug 3 illustrated in FIGS. 7 and 8, the acceleration sensor 5 is installed in close vicinity of the rear end of the heating rod 12. The acceleration sensor 5 is fastened to a substrate 8, which is connected to the ceramic isolator 12a via an isolator body 11, which insulates the internal pole 18 of the glow plug 3 against the sheath of the heating rod 12. The heating current is conveyed to the heating rod 12 via the internal pole 18. In the example of FIGS. 7 and 8, the acceleration sensor 5 does not enclose the internal pole 18. Instead, the internal pole 18 of the heating rod 12 is connected to a supply line 10, which bypasses the acceleration sensor 5. A signal line 20 runs from the acceleration sensor 5, which can be for instance a shielded cable or a flexfoil, on which in addition to electrical lines a processor for the interpretation of the acceleration signals may be placed as well, to the electrical glow plug connection 9. The acceleration sensor 5 is in the example of FIGS. 7 and 8 a MEMS Sensor, for instance of the kind as described above.

The provision of an acceleration sensor 5 in a glow plug 3 not only enables to draw conclusions about the variation in time of the relative combustion pressure in the combustion chamber 1 on the basis of the acceleration signal. It is also possible to observe the noise generation in the engine and monitor it for anomalies. Knocking in the respective combustion chamber 1 can be detected and be reduced or eliminated by controlling the combustion. The curve of the acceleration signal enables to determine the ignition timing and to acquire insights on the propagation of the flame front in the combustion chamber 1. Finally, it is also possible to measure the accelerations acting upon the glow plug 3 during the engine operation and to use them as input data for an operating strength analysis and for accelerated service life testing (Highly Accelerated Life Test, HALT). Finally, the acceleration signals acquired from an acceleration sensor 5 in the glow plug 3 can also be used to control or to regulate the temperature to which the glow plug is heated, depending on the acceleration signals occurring, individually for every combustion chamber 1 of the engine.

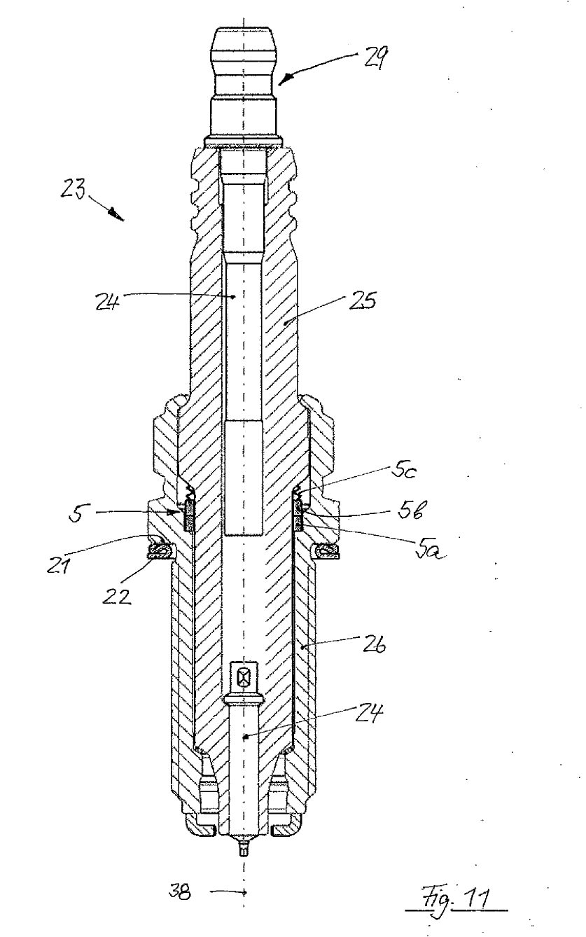

The exemplary illustrated in FIG. 9 differs from the embodiment illustrated in FIG. 1 in that it does not relate to a diesel engine but rather to an Otto engine. Consequently, a spark plug 23 is provided instead of a glow plug 3. An acceleration sensor 5 is provided in the housing 26 of the spark plug 23, in addition to the components which usually form a spark plug. The sensor can be combined with an analyzing circuit or parts of an analyzing circuit to constitute a unit for processing the measuring signals delivered by the acceleration sensor 5. If the analyzing circuit is not provided in the housing 26 of the spark plug 23 it can be situated in a control apparatus 4.

The acceleration sensor 5 can also in such a case be single axis, double axis or triple axis, i.e. it can measure accelerations which occur in one, in two or in three different space axes. Due to its arrangement in the combustion chamber roof 7 or on the combustion chamber roof 7, the acceleration sensor 5 first and foremost reacts to accelerations which occur on the combustion chamber roof 7 and on the spark plug 3 and is excited first and foremost by the combustion process in the corresponding combustion space 1a and/or possibly by moving components associated with the combustion chamber 1, in particular by the piston 2, by valves belonging to the combustion chamber 1 and the drive elements thereof.

Good mechanical connection of the acceleration sensor 5 to the combustion chamber roof 7 is important, since that the accelerations occurring on the combustion chamber roof 7 are transmitted to the acceleration sensor 5 with smallest possible damping and in a high bandwidth. To that end, an arrangement of the acceleration sensor 5 in the height of the combustion chamber roof 7 and in particular in the combustion chamber roof 7 in the vicinity of its underside is particularly advantageous. Good mechanical connection goes along with good thermal connection of the acceleration sensor 5 to the combustion chamber roof 7. The combustion chamber roof 7, which is generally designed as a removable cylinder head is usually force cooled, i.e. it is streaked with cooling channels, through which a cooling fluid of the engine is pumped. The temperature of the acceleration sensor 5 arranged in the height of the combustion chamber roof 7 respectively in the combustion chamber roof 7 will therefore remain below the temperature of 150° C., which is critical for electrical and electronic components.

The dynamic processes, which take place in the combustion chamber 1, are the main cause for the accelerations occurring on the combustion chamber roof 7 and on the spark plug 23. The acceleration signals provided by the acceleration sensor 5, their strength and in particular their variation in time therefore enable to draw conclusions about the combustion process taking place in the combustion chamber 1 and to observe for instance the ignition timing and upon completed ignition the rapidity of the propagation of the flame front. The acceleration sensor 5 integrated into the spark plug 23 can provide measured values which may be used by an engine control device as input data for controlling or regulating the combustion cycle or by a spark plug control apparatus as input data for controlling or regulating the sparking process of the spark plug 23.

FIGS. 10 to 11 show two different possibilities, of the position at which an acceleration sensor 5 can be arranged in the housing 26 of the spark plug 23. In both cases a thread 27 is situated in the front section of the spark plug 23 on the outside of the housing 26, which thread enables to screw in the spark plug 23 into a threaded bore provided to that end in the combustion chamber roof 7, which can be a removable cylinder head. A shoulder 21 connects to the external thread 27, in front of which shoulder a seal ring 22 rests. This ring works together with a sealing seat formed in the combustion chamber roof 7.

In the embodiment of the spark plug 23 illustrated in FIG. 10, the acceleration sensor 5 is provided in the height of the external thread 27 and in the vicinity of the ignition electrodes of the spark plug 23. This position is ideal for observing the combustion process by means of the acceleration sensor 5, since the acceleration sensor 5 rests directly above the combustion space 1a. Moreover, the cooperation between shoulder 21, seal ring 22 and sealing seat in the combustion chamber roof 7 provides an outstanding mechanical contact from the acceleration sensor 5 to the combustion chamber roof 7. Optimal prerequisites for measuring accelerations are thus provided, which find their origin in combustion cycles which take place in the combustion chamber 1.

The acceleration sensor 5 is annular respectively integral part of an annular unit, lies preferably coaxially to the longitudinal axis 38 of the spark plug 23 in a recess 28, which is formed between the housing 26 and the ceramic isolator 25 of the spark plug 23. Thanks to the good contact with the cooled combustion chamber roof 7, the acceleration sensor 5 remains at a temperature below 150° C. The assembly of the acceleration sensor 5 corresponds to that in the glow plug according to FIG. 6. Signal lines 20 may be conveyed for instance as shielded lines on a flexfoil in a gap between the isolator 25 and the housing 26 to the electrical spark plug connection 29.

The advantages, which have been offered for the arrangement of an acceleration sensor in a glow plug, are also valid correspondingly for the integration of an acceleration sensor in a spark plug.

In the embodiment illustrated in FIG. 11, the acceleration sensor 5 respectively a unit containing said sensor is also annular and is preferably arranged coaxially to the longitudinal axis 38 of the spark plug 23, however—compared with FIG. 10—shifted closer towards the cold end of the spark plug 23. It is roughly situated in the middle of the spark plug 23 in a recess 28, which is arranged in the housing 26 of the spark plug 23 in the height of the annular shoulder 21. The mechanical contact and the thermal contact between the spark plug 23 and the cooled combustion chamber roof 7 are particularly suitable at that location and hence the thermal and mechanical coupling of the acceleration sensor 5 to the combustion chamber roof 7 also quite good. Acceleration signals, which find their origin in combustion cycles in the combustion space 1a, reach the acceleration sensor 5 as well over the metal housing 26 of the spark plug 23 as over the metal combustion chamber roof 7.

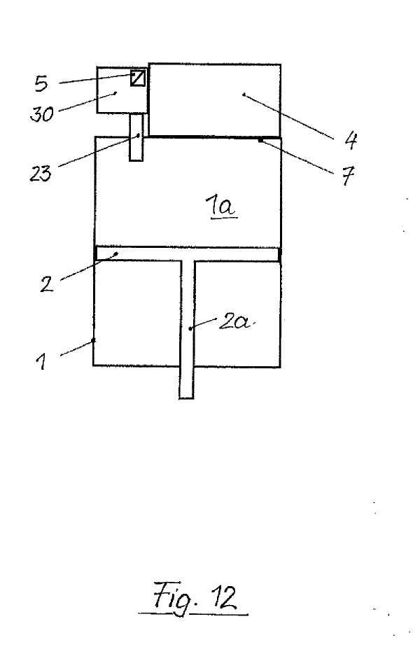

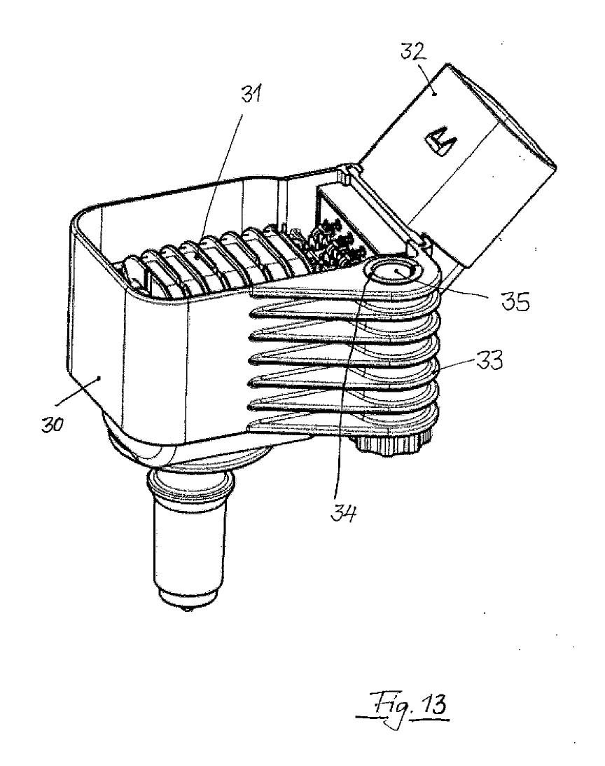

The embodiment illustrated in FIG. 12 differs from the embodiment illustrated in FIG. 9 substantially in that that the acceleration sensor is not incorporated into a spark plug 23, but rather placed inside the housing 30 of an ignition coil 31 or be installed outside on the housing 30 of an ignition coil 31. The ignition coil 31 is connected to the spark plug 23 mounted in the engine. The housing 30 of the ignition coil 31 is screwed on to the engine block, in particular to the combustion chamber roof 7, for instance to a combustion chamber roof 7 designed as a removable cylinder head.

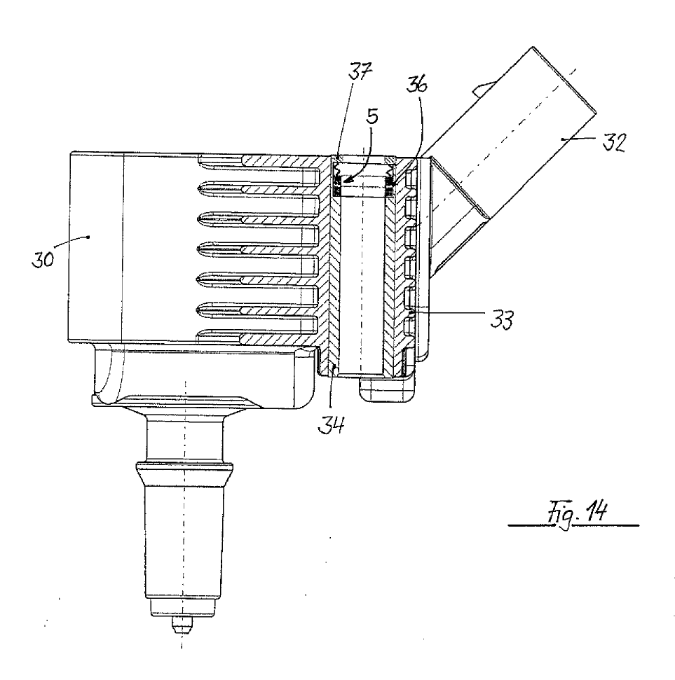

FIGS. 13 and 14 show an embodiment for the integration of an acceleration sensor 5 in a housing 30 of a ignition coil 31. The housing 30 is shown in an oblique view in FIG. 13, whereas a cover of the housing 30 is removed so that the ignition coil 31 can be seen. An electrical plug-in connector 32 is provided outside on the housing 30. An eye 34 is formed in a base 33 of the housing 30, with which the housing 30 can be fastened to a stud 35, which is provided on the combustion chamber roof 7.

As shown on FIGS. 14 to 16, the acceleration sensor 5 is situated in a recess 36 of the eye 34 and is held therein by a supporting ring 37. The acceleration sensor 5 or a unit incorporating said sensor encloses the stud 35 inserted in the eye 34 in annular fashion. In this arrangement, the acceleration sensor 5 is situated in immediate vicinity of the combustion chamber roof 7 directly above the combustion space 1a. Optimal prerequisites for measuring acceleration signals are thereby provided, which are caused by combustion processes in the combustion space 1a.

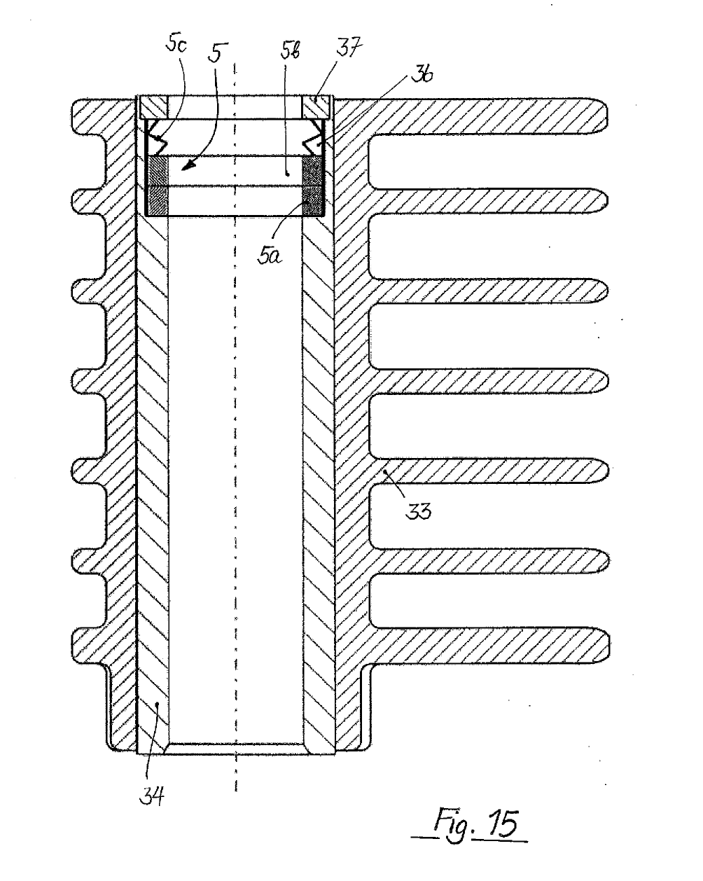

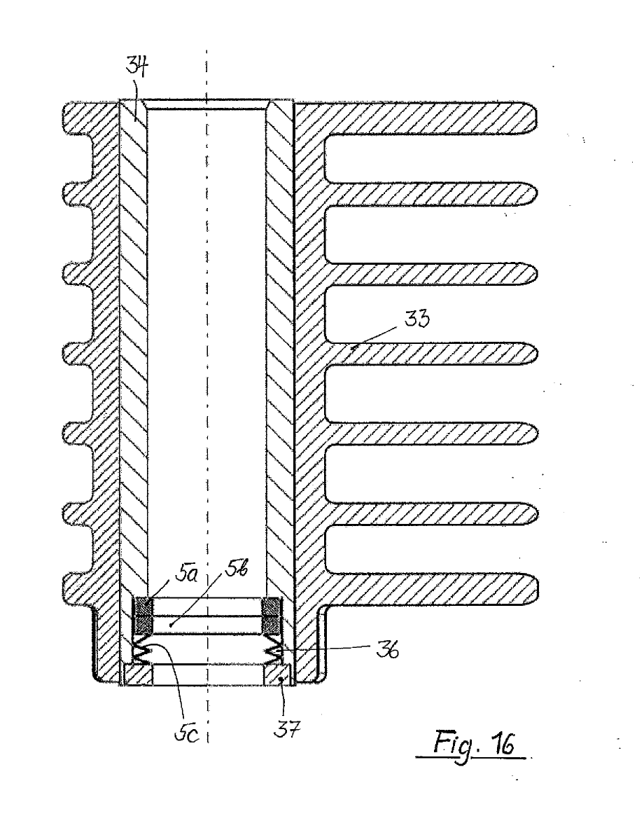

FIGS. 15 and 16 show two different possibilities, to arrange the acceleration sensor 5 in the eye 34. In both cases, for instance a piezoelectric acceleration sensor 5 is provided, as described in connection with FIG. 6. Reference is made to the description of FIG. 6. In the example of FIG. 15, the spring 5c is arranged above and the piezoelectric body 5a below. In the embodiment according to FIG. 16, the sequence is reversed. The seismic mass 5b is situated in both cases between the spring 5c and the piezoelectric body 5a.

In connection with an ignition coil 31, acceleration sensors other designs can also be used, in particular also the MEMS-acceleration sensors already aforementioned, among which an example in connection with FIG. 8 was described, to which reference is made here.

Also in the embodiments, which are illustrated in FIGS. 12 to 16, electrical contacting and signal output of the acceleration sensor 5 can be via to cables or lines, which are printed on a substrate, which can be rigid or flexible, for instance a flexfoil, on which a processor can also be placed for signal interpretation. The lines are preferably shielded. For the sake of simplicity, the electrical bonding and the running of lines is not represented in FIGS. 13 to 16.

The advantages, which have been explained in the context of the arrangement of an acceleration sensor 5 in a glow plug 3 or in a spark plug 23, are correspondingly valid for the use of an acceleration sensor 5 in the or on the housing 26 of an ignition coil 31.

### LIST OF REFERENCE NUMBERS

1. Combustion chamber
1a. Combustion space
2. Piston
2a. Connecting rod
3. Glow plug
4. Control apparatus
5. Acceleration sensor
5a. Piezoelectric body
5b. Seismic mass
5c. Annular spring
6. Housing of the glow plug
7. Combustion chamber roof/cylinder head
8. Substrate
9. Electrical glow plug connection
10. Supply line
11. Isolator body
12. Heating rod
12a. Ceramic isolator
13. Glow tip
14. Channel
15. Cooling channels
16. Sealing surface
17. Sealing seat
18. Internal pole
19. Recess
20. Signal line
21. Sealing seat, formed as a shoulder
22. Seal ring
23. Spark plug
24. Central electrode
25. Ceramic isolator
26. Housing of the spark plug
27. External thread on 26
28. Recess
29. Electrical spark plug connection
30. Housing of an ignition coil
31. Ignition coil
32. Electrical plug-in connector
33. Base of 30
34. Eye
35. Stud
36. Recess
37. Supporting ring
38. Longitudinal axis of the ignition device

What is claimed is:

1. An ignition device for a combustion engine with one or several combustion chambers, each chamber having an ignition device associated therewith, each device comprising an acceleration sensor responsive to a measurement, influenced by a combustion process taking place in a respective combustion chamber.

2. An ignition device according to claim 1, wherein the acceleration sensor provides an electrical output signal.

3. An ignition device according to claim 2, wherein the acceleration sensor has a seismic mass, and the device further comprises a spring for biasing the seismic mass against a piezoelectric body for generating the electrical output signal under the effect of the seismic mass.

4. An ignition device according to claim 2, wherein the acceleration sensor is designed as a microelectromechanical system (MEMS Sensor).

5. An ignition device according to claim 1, wherein the ignition device has a component with a longitudinal axis and that the acceleration sensor is arranged coaxially to the longitudinal axis of this component.

6. An ignition device according to claim 5, wherein the acceleration sensor encloses the component.

7. An ignition device according to claim 1, wherein the acceleration sensor is a multi-axis sensor.

8. An ignition device according to claim 1, further comprising a glow plug and the acceleration sensor is installed in the glow plug.

9. An ignition device according to claim 8, wherein the glow plug has a heating rod with a glow tip reaching into a combustion space of the combustion chamber, and the acceleration sensor encloses the heating rod on a end remote from the combustion chamber and is held in a recess of a housing of the glow plug.

10. An ignition device according to claim 8, wherein the glow plug includes a housing, a heating rod held in the housing, the heating rod having a glow tip protruding into the combustion space of the combustion chamber, the glow plug also comprising an electrical glow plug connection provided on a rear end of the housing and an electrical supply cable leading from said connection to the heating rod and that the acceleration sensor is held in a recess of the housing and encloses the electrical supply line.

11. An ignition device according to claim 1, further comprising a spark plug and the acceleration sensor is installed in the spark plug.

12. An ignition device according to claim 11, wherein the spark plug includes a metal housing, an electrode leading centrally through the housing and an isolator holding the electrode to provide electrical insulation with respect to the housing, the isolator being enclosed by the acceleration sensor.

13. An ignition device according to claim 12, wherein the acceleration sensor is arranged and held in a ring-shaped recess formed between an inside of the housing and an outside of the isolator.

14. An ignition device according to claim 8, wherein a sealing seat is arranged on the glow plug respectively on the spark plug and in that the acceleration sensor is installed in a height of the sealing seat.

15. An ignition device according to claim 1, further comprising an ignition coil and the acceleration sensor is fastened in or on a housing of the ignition coil.

16. An ignition device according to claim 15, wherein the housing of the ignition coil includes an eye, provided for fastening the housing onto the combustion engine, and that the acceleration sensor is arranged in an annular fashion on the eye.

17. An ignition device according to claim 1, wherein the acceleration sensor is provided in a housing of the ignition device, through which a corona discharge is generated in the combustion chamber.

18. A device comprising a combustion engine with one or several combustion chambers, and an ignition device including an acceleration sensor associated with each chamber and responsive to a measurement influenced by a combustion process taking place in the respective combustion chamber.

19. A combustion engine according to claim 18, wherein the combustion chamber is closed by a combustion chamber roof in a close environment of the ignition device and that the acceleration sensor is fastened in or on the combustion chamber roof.

20. The use of an ignition device according to claim 1 for determining the ignition timing and/or the combustion pressure, including a variation in time of the combustion pressure and/or of combustion parameters including AQ10 and/or AQ50 and/or of the noise level and/or of knocking sounds and/or of vibrations, which are generated by other components including compensation shafts or turbo chargers and/or for carrying out highly accelerated life cycle testing (HALT) and/or for establishing parameters for an operating strength analysis of the ignition device.
